(19) United States
(12) Patent Application Publication
(10) Pub. No.: US 2012/0031092 A1
(43) Pub. Date: Feb. 9, 2012

(54) Internal combustion engine and method for operating an internal combustion engine

(76) Inventors: Siegfried Sumser, Stuttgart (DE); Peter Fledersbacher, Stuttgart (DE); Paul Löffler, Stuttgart (DE); Torsten Hirth, Rutesheim (DE)

(21) Appl. No.: 13/317,573

(22) Filed: Oct. 21, 2011

Related U.S. Application Data
(63) Continuation-in-part of application No. PCT/EP10/01304, filed on Mar. 3, 2010.

(30) Foreign Application Priority Data
Apr. 23, 2009 (DE) 10 2009 018 583.6

(51) Int. Cl. F02D 23/00; F02B 37/18

(52) U.S. Cl. 60/602

(57) ABSTRACT

In an internal combustion engine with a high pressure exhaust gas turbocharger and a low pressure exhaust gas turbocharger connected in series, a bypass line including a blow-off valve extending around the high pressure and connected to the turbine of the low pressure exhaust gas turbocharger so that the exhaust gas can be conducted into a first inlet flow passage of the low pressure turbine in radial direction of the turbine wheel, the low pressure exhaust gas turbocharger comprises a second inlet flow by means of which the exhaust gas from the high pressure is directed onto the turbine wheel of the low pressure exhaust gas turbocharger in an axial or semi-axial flow direction.

This is a Continuation-In-Part application of pending international patent application PCT/EP2010/001304 filed Mar. 3, 2010 and claiming the priority of German patent application 10 2009 018 583.6 filed Apr. 23, 2009.

### BACKGROUND OF THE INVENTION

The invention relates to an internal combustion engine with a high pressure and a low pressure exhaust gas turbocharger arranged in series and with a bypass line extending around the turbine of the high pressure turbocharger, and to a method for operating an internal combustion engine with such a turbocharger arrangement.

Such internal combustion engines, in particular diesel engines of utility vehicles, with exhaust gas recirculation have long been known. Such a recirculation is used to lower nitrogen oxides, thus NOₓ emissions, in order to comply with threshold values laid down by legislation. These threshold values, which have been further strengthened by the legislator, for example by the Euro 6 standard, require further raising of exhaust gas recirculation rates. This raising of the exhaust gas recirculation rates means a requirement for higher charging pressures for charging units in the form of exhaust gas turbochargers of such internal combustion engines so as not to suffer excessive loss of power of the internal combustion engine.

Although in the recent past an absolute level of the maximum charging pressures has increased from approximately 3.5 bar to 4.5 bar, in the near future—but at least in the medium term—a charging pressure requirement in some operating phases of the internal combustion engine will have to increase to approximately 6 bar. This may require a change from single stage charging to dual stage charging arrangement.

For a broad application in internal combustion engines for utility vehicles as well as passenger cars it is possible to further develop a concept of a series arrangement of a low pressure exhaust gas turbocharger and a high pressure exhaust gas turbocharger. Such concepts are already known. In such a dual stage charging concept an internal combustion engine is provided with a high pressure exhaust gas turbocharger and a low pressure exhaust gas turbocharger arranged in series therewith. A bypass is additionally provided, by means of which an exhaust gas can flow around a turbine of the high pressure exhaust gas turbocharger at an exhaust gas side of the internal combustion engine. This means therefore that the bypass is in the form of a blow-off unit, through which exhaust gas, which normally flows through the turbine of the high pressure exhaust gas turbocharger, can bypass this turbine. This blow-off unit is, however, a substantial loss generator. At this point there occurs a conversion of a large amount of energy into useless throttle energy (heat) by bypassing the turbine of the high pressure exhaust gas turbocharger. This bypassing of the turbine of the high pressure exhaust gas turbocharger however is necessary for controlling the two exhaust gas turbochargers so as to avoid overcharging of the corresponding internal combustion engine by the usually very small turbine of the high pressure turbocharger in an upper speed-load range of the internal combustion engine. The conversion of a large amount of energy as described into useless throttle energy means a considerable loss in the degree of efficiency of the turbine of the high pressure exhaust gas turbocharger and thus a reduction in the degree of efficiency of the whole high pressure exhaust gas turbocharger or the whole charging system resulting in an increased fuel consumption and increased CO₂ emissions of the internal combustion engine go hand in hand therewith.

It is thus desirable to achieve an improvement in an overall degree of efficiency of such a dual stage charging system and simultaneously to avoid discontinuities in relation to an exhaust gas pressure and a charging pressure at an air intake side of the internal combustion engine.

It is the principal the object of the present invention to further develop an internal combustion engine of the type mentioned initially in such a way that an increased overall degree of efficiency of the internal combustion engine is achieved.

### SUMMARY OF THE INVENTION

In an internal combustion engine with a high pressure exhaust gas turbocharger and a low pressure exhaust gas turbocharger connected in series, a bypass line including a blow-off valve extending around the high pressure and connected to the turbine of the low pressure exhaust gas turbocharger so that the exhaust gas can be conducted into a first inlet flow passage of the low pressure turbine in radial direction of the turbine wheel, the low pressure exhaust gas turbocharger comprises a second inlet flow by means of which the exhaust gas from the high pressure is directed onto the turbine wheel of the low pressure exhaust gas turbocharger in an axial or semi-axial flow direction.

Advantageous embodiments with useful and non-trivial developments of the invention are defined in the dependent claims.

The bypass is provided with a blow-off valve arranged in a turbine housing of the low pressure exhaust gas turbocharger, whereby the exhaust gas flow around the turbine of the high pressure exhaust gas turbocharger can be controlled and the exhaust gas can be conducted to an inlet of the turbine of the low pressure exhaust gas turbocharger. To this end, the turbine of the low pressure exhaust gas turbocharger comprises a first inlet flow, by means of which the high pressure exhaust gas can be conducted to a turbine wheel disposed in the turbine housing of the low pressure exhaust gas turbocharger essentially in radial direction of the turbine wheel. The turbine of the low pressure exhaust gas turbocharger also comprises a second inlet flow passage, by means of which the exhaust gas can be fed to the turbine wheel of the low pressure exhaust gas turbocharger substantially transverse or diagonal to the radial direction at a lower wheel inlet diameter of the turbine wheel that is in an axial or rather semi-axial direction.

The supply substantially diagonal or transverse to the radial direction of the turbine wheel thereby means that the lower pressure exhaust gas can be fed essentially from the rear of the turbine wheel of the low pressure exhaust gas turbocharger to the turbine wheel. An increase in the degree of efficiency of such a dual stage charging system is achieved on the one hand in that the turbine of the low pressure exhaust gas turbocharger is formed according to the invention so that it offers two different inflow diameters for the exhaust gas, namely a first inflow diameter of the exhaust gas fed to the turbine wheel of the low pressure exhaust gas turbocharger in the form of the described radial admission for the high pressure exhaust gas from the bypass line and a second, smaller inflow diameter for conducting the exhaust gas of the low pressure exhaust gas turbocharger to the turbine wheel. The second inflow passage extends at an oblique angle or diagonal to the radial direction of the turbine wheel, that is, quasi-axially or semi-axially.

This second diameter thereby refers to an area-dividing diameter of an inlet flow area, through which the exhaust gas enters with an axial or semi-axial admission to the turbine wheel.

Two different inflow diameters of the turbine of the low pressure exhaust gas turbocharger are thus created, whereby a more efficient adaptation of the turbine of the low pressure exhaust gas turbo charger to different operating points of the corresponding internal combustion engine is possible. This permits a more efficient operation, which is thus more favorable to the degree of efficiency, of this turbine while simultaneously ensuring a required and desired air supply of the internal combustion engine to realize a required moment. This results in a reduction in the fuel consumption and CO₂ emissions of the internal combustion engine.

By regulating said blow-off valve the exhaust gas can be distributed to the individual different inlet flow passages in depending on the operating point of the internal combustion engine, whereby the operation of the turbine of the low pressure exhaust gas turbocharger can be optimally adapted to the momentary operating point of the internal combustion engine in order to achieve advantages in the form of a lower fuel consumption and lower CO₂ emissions.

It is thus made possible by the inventive internal combustion engine to convert an energy of a blow-off quantity of the exhaust gas which has bypassed the turbine of the high pressure exhaust gas turbocharger by way of the bypass valve arranged directly before the turbine wheel of the low pressure exhaust gas turbocharger into speed energy and to then convey this speed energy directly in the subsequent turbine wheel into mechanical work.

The exhaust gas can be conveyed advantageously by means of the bypass into the first inlet flow of the turbine of the low pressure exhaust gas turbocharger. The exhaust gas which has bypassed the turbine of the high pressure exhaust gas turbocharger by means of the bypass is thus not expanded through the turbine of the high pressure exhaust gas turbocharger and thereby has a higher pressure. For this reason it is ideally to be conveyed to a large inflow diameter of the subsequent turbine wheel of the low pressure exhaust gas turbocharger, as a larger inflow diameter is desirable with a higher pressure ratio—whereby this is the case due to the non-expanded exhaust gas—since a tip speed ratio of the turbine of the low pressure exhaust gas turbocharger is facilitated at or at least close to the optimum of 0.7. This means a particularly efficient operation of the turbine of the low pressure exhaust gas turbocharger, whereby a further increase in the degree of efficiency of the turbine of the low pressure exhaust gas turbocharger and thus the corresponding internal combustion engine is achieved. This goes hand in hand with the advantage of a further reduction in the fuel consumption and the CO₂ emissions.

In summary this means therefore that due to the higher pressure of the bypassed exhaust gas a higher pressure ratio is facilitated. This is advantageously due to a larger inflow diameter of the turbine wheel of the low pressure exhaust gas turbocharger, which is facilitated by the internal combustion engine in order to reach an optimum tip speed ratio of the turbine of the low pressure exhaust gas turbocharger.

The exhaust gas expanded through the turbine of the high pressure exhaust gas turbocharger can thereby be conveyed to the second flow path of the turbine of the low pressure exhaust gas turbocharger by means of a guide impact nozzle lying on the described inflow diameter on the back of the turbine wheel of the low pressure exhaust gas turbocharger. This exhaust gas has a lower pressure level, from which a low pressure gradient or pressure ratio follows. An optimum operation of the turbine of the low pressure exhaust gas turbocharger is thereby facilitated in that this exhaust gas is conveyed with a lower pressure level also onto the smaller inflow diameter of the turbine of the low pressure exhaust gas turbocharger.

An internal combustion engine is thus provided, wherein the exhaust gas can be supplied as required, namely in dependence upon its pressure level, to the turbine of the low pressure exhaust gas turbocharger in order to achieve a high degree of efficiency of the internal combustion engine.

In an advantageous embodiment of the invention the blow-off valve, which is thus provided to control the bypass of the turbine of the high pressure exhaust gas turbocharger, is arranged in a wheel inlet region of the turbine wheel. This results in a very compact construction of the turbine of the low pressure exhaust gas turbocharger. Package problems can thereby be resolved which can prove extremely critical in particular in an engine compartment, in which the internal combustion engine and thus the turbine of the low pressure exhaust gas turbocharger are arranged.

If the blow-off valve is arranged in the first inlet flow passage, that is in the inlet flow passage via which the exhaust gas can be supplied to the turbine wheel of the turbine of the low pressure exhaust gas turbocharger in radial direction, this brings with it the advantage that at this point the blow-off valve can be arranged in a particularly favorable, low resource- and space-saving way. This results in a reduction both in the production and assembly expenses for the low pressure exhaust gas turbocharger, which goes hand in hand with a reduction in the costs of the low pressure exhaust gas turbocharger and thus the internal combustion engine.

In a further advantageous embodiment of the invention the blow-off valve comprises at least one guide vane element, but ideally a plurality of guide vane elements, which are distributed around a periphery of the turbine wheel of the low pressure exhaust gas turbocharger. The exhaust gas can thereby be supplied to the turbine wheel in a particularly favorable and efficient way with respect to an inflow angle. This facilitates an even more efficient operation, which results in turn in a further reduction in the fuel consumption and the CO₂ emissions of the internal combustion engine. The blow-off valve thus constitutes a swirl generator which positively influences flow parameters of the exhaust gas through its nozzle channels.

If the at least one guide vane element of the blow-off valve is mounted rotatably in the form of the swirl generator an optimum adaptation of the flow parameters to an operating point of the internal combustion engine is thereby possible. In high load regions of the internal combustion engine it can thereby be provided to enlarge a flow cross-section through an opening of the rotatable guide vane element. This allows a low exhaust gas counter pressure and a maximum compressor power of the exhaust gas turbocharger to be achieved to provide a high desired moment and a high desired power of the internal combustion engine. In low load regions the flow cross-section can be closed again by rotating the guide vane element in order to realize a particularly good reaction behavior of the exhaust gas turbocharger or the low pressure exhaust gas turbocharger. With regard to any aspect an operation of the low pressure exhaust gas turbocharger can advantageously be adapted to an operating point of the internal combustion engine.

It can also be provided that the blow-off valve is formed as a variable guide baffle, whereby the flow parameters can be further positively influenced.

In an advantageous embodiment of the invention the blow-off valve comprises a slidable adjustment device, by means of which the flow cross-section, through which the exhaust gas flows, can be influenced. As already described in connection with the rotatable guide vane element, the flow cross-section can thereby be adapted to operating points of the internal combustion engine for further improvement of adaptability of the low pressure exhaust gas turbocharger to operating points of the internal combustion engine in order to thus facilitate a further reduction in the fuel consumption and the CO₂ emissions thereof.

Preferably the adjusting device is in the form as a vane structure, or a variable guide baffle by which the gas inlet flow passage can be blocked at least in areas. The flow cross-section can thus be enlarged or reduced in a particularly favorable way and in particular in a gas-tight way in order to optimize the adaptability of the low pressure exhaust gas turbocharger.

By selecting a diameter of the turbine wheel of the low pressure exhaust gas turbocharger downstream of the blow-off valve in the form of the variable swirl generator an axial wheel inlet is obtained with an average inflow diameter. Thus the above-described area-dividing inflow diameter of the flow cross-section, through which the exhaust gas flows, can be fed to the turbine wheel of the low pressure exhaust gas turbocharger substantially transverse or diagonal in the radial direction of the turbine wheel. This provides for an additional degree of design freedom for he pairing of the two tip speed ratios Uₐₓ/C₀ₐₓ and U_{rad}/C_{0rad} on both turbine inlet flange cross-sections of the turbine of the low pressure exhaust gas turbocharger. The tip speed ratio Uₐₓ/C₀ₐₓ thereby refers to the described axial wheel inlet and the tip speed ratio U_{rad}/C_{0rad} thereby refers to the above-described larger inflow diameter in relation to the radial supply of the exhaust gas to the turbine wheel of the low pressure exhaust gas turbocharger. As both inlet flows extend in a gas-tight and separate manner, through the bypassing of the turbine of the high pressure exhaust gas turbocharger on the basis of different inlet temperatures and inlet pressures of the exhaust gas a ratio of the isentropic speeds of the tip speed ratios between two gas flows in the inlet flows of C₀ₐₓ<C_{rad} results.

By means of an inflow diameter ratio of the two above-described wheel inlets, which is proportional to the ratio of the peripheral speeds of the tip speed ratios Uₐₓ<U_{rad}, there is now, with such a turbine type of the low pressure exhaust gas turbocharger for the inventive application, a further degree of optimization freedom in relation to influencing the degree of efficiency of the turbine of the low pressure exhaust gas turbocharger via a tip speed ratio compensation of both gas flows in the inlet flows with asymmetrical turbine impacting. The turbine of the low pressure exhaust gas turbocharger is accordingly an extended asymmetrical turbine which allows fixing of two inflow diameters from one turbine wheel side.

If a displaceable adjustment device for influencing flow parameters, in particular a conical slide, is provided in a wheel outlet region of the turbine outlet region of the turbine wheel, this has the advantage that a further degree of freedom for the optimal adaptation of the operation of the turbine of the low pressure exhaust gas turbocharger to operating points of the corresponding internal combustion engine is created. This results in a further possibility for reducing the fuel consumption and the CO₂ emissions.

It should be noted at this point that the described devices influencing flow parameters can be used also in association with the high pressure exhaust gas turbocharger, both at a wheel outlet and also at a wheel inlet of the turbine wheel of the turbine of the high pressure exhaust gas turbocharger. The facts stated in connection with the turbine of the low pressure exhaust gas turbocharger also apply similarly with regard to the advantages. It can also be provided that compressors of the respective exhaust gas turbochargers with flow parameter influencing adjustment devices can be formed in a wheel inlet region or in a wheel outlet region of a compressor wheel of the respective compressor.

In a particularly advantageous embodiment of the invention the inlet flows have essentially asymmetrical flow cross-sections. This asymmetry thereby relates possibly both to the inlet flows in relation to each other and to the respective flow cross-section corresponding to an inlet flow. The inlet flows can thereby ideally be adapted to flow conditions of the exhaust gas, whereby flow losses can be minimized and thus a proportion which is as large as possible of energy transported through the exhaust gas can be converted into mechanical work in order to further increase the degree of efficiency of the turbine of the low pressure exhaust gas turbocharger. This reduction in the losses means a reduction in the fuel consumption and the CO₂ emissions of the corresponding internal combustion engine. If the inlet flows are of different sizes, i.e. a larger flow and a smaller flow exist, a precondition for an optimal exhaust gas recirculation (EGR) is thereby created for example, whereby NO emissions of the internal combustion engine can be reduced particularly efficiently.

A further aspect of the invention provides that the turbine of the low pressure exhaust gas turbocharger comprises a collecting chamber in the first inlet flow. This is advantageous insofar as a further adaptability to flow conditions of the exhaust gas is thereby created. For example a build-up behavior of the turbine for realization of an optimal exhaust gas recirculation can thereby be realized, whereby the advantages described in this connection go hand in hand therewith.

If the turbine housing of the low pressure exhaust gas turbocharger is designed as a segment housing this means that over a periphery of the turbine housing inlet flows exist which are separated in a gas-tight way. A plurality of flows thereby results, which can flow to the turbine wheel. This means particularly in connection with the first inlet flow that, if a second inlet flow exists, at least three flows thus exist. It is thereby facilitated that for example a certain number of cylinders can be brought together in the internal combustion engine and their exhaust gas can be conveyed to an inlet flow in order to realize the most varied applications for optimal adaptation of the turbine to operating points of the internal combustion engine. It can likewise be provided that by means of the segment housing the aforementioned collecting chamber is formed within the scope of such a segment housing.

Alternatively the turbine housing of the low pressure exhaust gas turbocharger can be in the form of a twin housing. This means therefore that a plurality of inlet flows running in parallel over the periphery of the turbine wheel are provided, by means of which likewise requirements of the most varied application possibilities can be fulfilled and the turbine can thus be adapted to these requirements. As already explained in connection with the segment housing, the collecting chamber can thereby be formed by means of such a twin housing. This means therefore that a plurality of separate collecting chambers exists. This also applies to the design of the turbine housing as a segment housing.

If therefore at least two separate collecting chambers are formed by means of the segment housing or by means of the twin housing, these can have a symmetrical or an asymmetrical build-up behavior, whereby maximization of the adaptability of the turbine to the most varied application possibilities, for example to exhaust gas recirculation, is created.

According to a further aspect of the invention a turbine wheel inlet diameter is formed to be equal to a turbine wheel outlet diameter of the turbine of the low pressure exhaust gas turbocharger. This provides for widening of a blow-off cross-section to very large values. This results in a particularly good bypassing of the turbine of the high pressure exhaust gas turbocharger through the large blow-off cross-section.

According to an inventive method for operating an internal combustion engine with a high pressure exhaust gas turbocharger and a low pressure exhaust gas turbocharger connected in series therewith, these respectively comprise at least on an exhaust gas side of the internal combustion engine a turbine through which the exhaust gas of the internal combustion engine can flow. By means of a bypass with a blow-off valve received by a turbine housing of the low pressure exhaust gas turbocharger the exhaust gas flows around the turbine of the high pressure exhaust gas turbocharger and the exhaust gas is conveyed in an inlet flow of the turbine of the low pressure exhaust gas turbocharger. It is thereby provided according to the invention in this inventive method that the exhaust gas is supplied, in dependence upon an operating point of the internal combustion engine, according to requirements to a turbine wheel received by the turbine housing of the low pressure exhaust gas turbocharger via a first inlet flow substantially in radial direction and/or via a second inlet flow substantially transverse or diagonal to the radial direction of the turbine wheel.

This means therefore that all advantages already described in association with the inventive internal combustion engine are facilitated. Through the inventive method there can thus be a flow to the turbine of the low pressure exhaust gas turbocharger or the turbine wheel in dependence upon an operating point of the internal combustion engine either on a larger inflow diameter or a smaller inflow diameter. The larger inflow diameter thereby relates to the radial supply of the exhaust gas to the turbine wheel and the smaller inflow diameter to the supply transverse or diagonal to the radial direction of the turbine wheel, whereby this supply can also be described as an axial or semi-axial supply. Energy of the exhaust gas, which is guided by means of the bypass around the turbine of the high pressure exhaust gas turbocharger, is not therefore wasted but instead converted in the turbine of the low pressure exhaust gas turbocharger into mechanical work. This provides for an increase in a degree of efficiency of the turbine of the low pressure exhaust gas turbocharger and thus of the corresponding internal combustion engine. This results in a lower fuel consumption and in lower CO₂ emissions thereof.

The exhaust gas is advantageously conveyed by means of the bypass into the first inlet flow of the turbine of the low pressure exhaust gas turbocharger, that is to say therefore to the larger inflow diameter passage. As already explained in connection with the inventive internal combustion engine, the bypassed exhaust gas has a higher pressure level, whereby a higher pressure gradient results on the turbine wheel. In case of such a high pressure gradient a higher inflow diameter is also desirable, which is created by the radial supply of the exhaust gas to the turbine wheel. The exhaust gas which has expanded through the turbine of the high pressure exhaust gas turbocharger can thereby be conveyed, as already described, to a smaller inflow diameter of the turbine wheel. This thus relates to the area dividing inflow diameter of the flow cross-section, through which the expanded exhaust gas flows upon flowing into the turbine wheel from a back of the wheel in axial or semi-axial direction. This means that therefore the turbine of the low pressure exhaust gas turbocharger can be operated at or close to the optimum of the tip speed ratio of 0.7. This means an efficient operation of the turbine and thus a further reduction in the fuel consumption and the CO₂ emissions of the internal combustion engine.

Advantageous embodiments of the internal combustion engine are thereby to be regarded as advantageous embodiments of the method.

Further advantages, features and details of the invention will become more readily apparent from the following description of several embodiments thereof with reference to the accompanying drawings. The features and feature combinations mentioned above in the description and the features and feature combinations mentioned below in the description of the figures and/or shown in the figures alone can be used not only in the respectively indicated combination but instead also in other combinations or standing alone without going outside of the scope of the invention.

### BRIEF DESCRIPTION OF THE DRAWING

FIG. 1 shows a circuit diagram of an internal combustion engine with dual stage charging with a high pressure exhaust gas turbocharger and a low pressure exhaust gas turbocharger,

FIG. 2 is a longitudinal sectional view of a turbine of a low pressure exhaust gas turbocharger according to FIG. 1,

FIG. 3 is a longitudinal sectional view of an alternative embodiment to FIG. 2 of a turbine of a low pressure exhaust gas turbocharger according to FIG. 1,

FIG. 4 shows a circuit diagram of an internal combustion engine with dual stage charging with an alternative embodiment to FIG. 1 of a high pressure exhaust gas turbocharger and a low pressure exhaust gas turbocharger, and

FIG. 5 shows a circuit diagram of an internal combustion engine with dual stage charging with an alternative embodiment to FIG. 1 and FIG. 4 of a high pressure exhaust gas turbocharger and a low pressure exhaust gas turbocharger with dual flow bypassing of a turbine of the high pressure exhaust gas turbocharger.

### DESCRIPTION OF PARTICULAR EMBODIMENTS

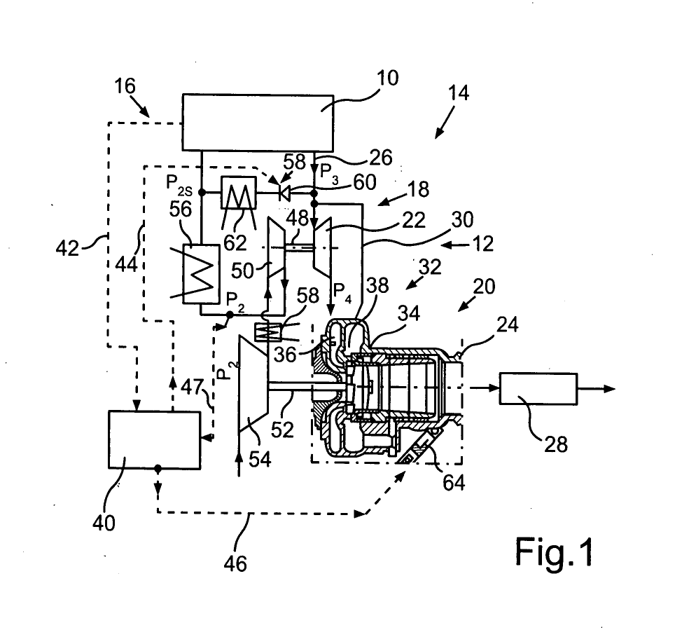

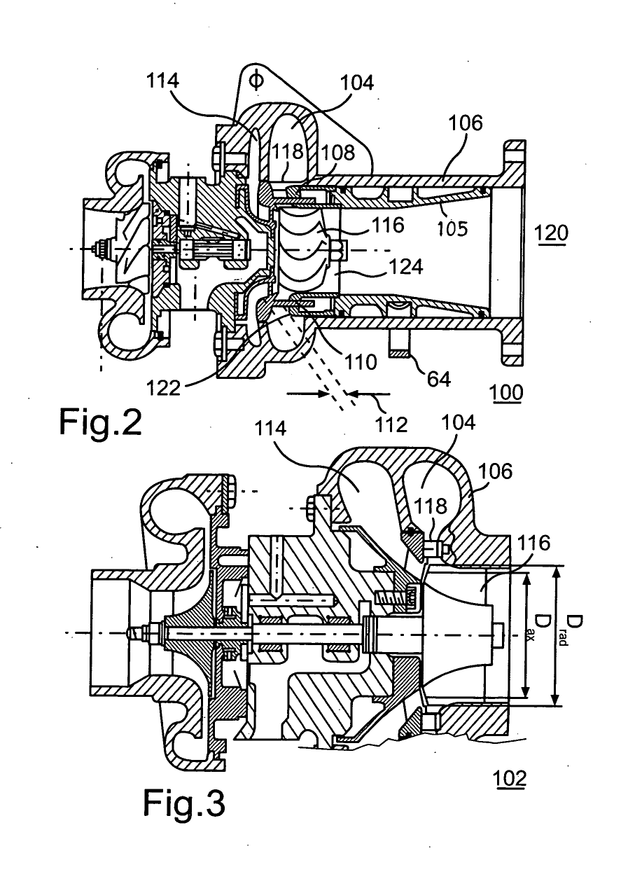

While FIGS. 1, 4 and 5 show circuit diagrams of a dual stage charged internal combustion engine, whereby different embodiments of a high pressure exhaust gas turbocharger or a low pressure exhaust gas turbocharger and a bypassing of a turbine of the high pressure exhaust gas turbocharger are shown, FIGS. 2 and 3 show possible embodiments of a turbine of a low pressure exhaust gas turbocharger, as can be used in a dual stage charged internal combustion engine according to FIGS. 1, 4 and 5.

FIG. 1 shows an internal combustion engine 10 with a dual stage charging system 12. The dual stage charging system thereby comprises a high pressure turbocharger 18 and a low pressure turbocharger 20. The high pressure turbocharger 18 comprises on an exhaust gas side 14 of the internal combustion engine 10 a high pressure turbine 22 and the low pressure turbocharger 20 comprises on the exhaust gas side 14 a low pressure turbine 24.

An exhaust gas of the internal combustion engine 10 flows according to a direction arrow 26 on the exhaust gas side 14 through the high pressure turbine 22 and further through the low pressure turbine 24, whereupon it flows through an exhaust gas processing installation 28, is purified by this and finally leaves to the environment. The high pressure turbine 22 can be bypassed in dependence upon operating points of the internal combustion engine 10 by means of a bypass 32 which comprises a bypass line 30 and a blow-off valve 34. As can be seen in FIG. 1, the exhaust gas of the internal combustion engine 10, which flows through the high pressure turbine 22, is conveyed into an inlet flow 36 of the low pressure turbine 24 and the exhaust gas which flows through the bypass line 30 is conveyed into an inlet flow 38 of the low pressure turbine 24. Impacting of the inlet flows 36 and 38 of the low pressure turbine 24 can thereby be regulated by means of said blow-off valve 34 of the bypass 32. The blow-off valve 34 is thereby formed as a variable radial guide vane structure and is arranged in an inlet region of a turbine wheel of the low pressure turbine 24.

As exhaust gas from the high pressure turbine 22 of the high pressure turbocharger 18 bypassed by means of the bypass line 30 has not expanded it has a high pressure level, whereby a high pressure gradient is created in the low pressure turbine 24 of the low pressure turbocharger 20. It is thus desirable for the thus bypassed exhaust gas to be conveyed to an inflow diameter of the turbine wheel of the low pressure turbine 24 which is as large as possible and to feed it via this large inflow diameter to the turbine wheel. This is realized precisely in that the bypassed exhaust gas is conveyed by means of the bypass line 30 precisely to the inlet flow 38 which provides for a radial flow to the turbine wheel.

The exhaust gas flowing through the high pressure turbine 20 which has a lower pressure level, resulting in a lower pressure gradient in the low pressure turbine 24, is conveyed via the inlet flow 36 to a lower inflow diameter of the turbine wheel. This exhaust gas flows to the turbine wheel diagonal or transverse to the radial direction of the turbine wheel from the back of the wheel.

The turbine wheel of the low pressure turbine 24 is coupled by means of a shaft 52 with a compressor wheel of a low pressure compressor 54. Said low pressure compressor 54 compresses the air supplied to the internal combustion engine 10 which is cooled by a first charging air cooler 58. The pre-compressed air flows further through a high pressure compressor 50 which comprises a compressor wheel which is connected via a shaft 48 to a turbine wheel of the high pressure turbine 22. The high pressure compressor 50 compresses the pre-compressed air further, whereupon it is in turn cooled by a second charging air cooler 56 and finally supplied to the internal combustion engine 10 to constitute a desired engine torque.

In addition an exhaust gas recirculation (EGR) system is provided which takes exhaust gas on the exhaust gas side 14 of the internal combustion engine 10 upstream of the high pressure exhaust gas turbocharger 18 and feeds it back via an EGR valve 60 and an EGR cooler 62 to an air side 16 of the internal combustion engine 10. A reduction of nitrogen oxides of the internal combustion engine 10 is thereby realized.

In order to regulate the mentioned components a control unit 40 is provided which, in dependence upon an engine operating point signal 42 and a charging pressure signal 47, regulates a re-circulated exhaust gas quantity 44 and a position 46 of the blow-off valve 34, which is indicated schematically by a dashed signal line. Depending upon the permitted charging pressure P2 a blowing-off or a bypassing of the high pressure turbine 22 by means of an adjustment of the blow-off valve 34 is influenced via the control unit 40, whereby the blow-off valve 34 is actuated via an actuator 64. The turbine integrated blow-off valve 34 is thereby changed in its position and a corresponding flow cross-section of the radial supply of the exhaust gas to the turbine wheel correspondingly modeled, that is to say increased or reduced.

In FIGS. 2 and 3 the same reference numerals indicate the same elements.

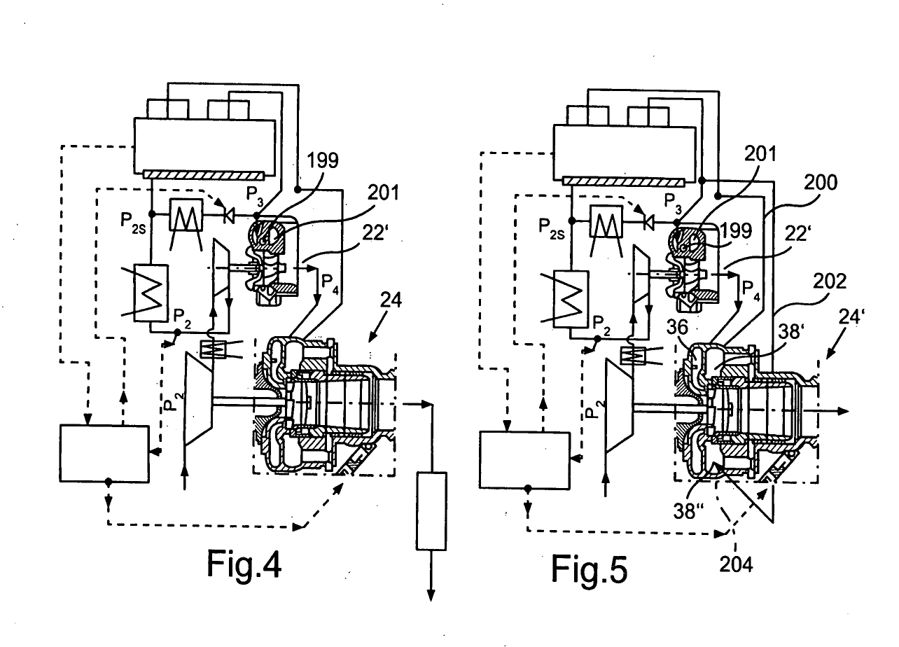

FIGS. 2 and 3 show turbines 100, 102 of an exhaust gas turbocharger for use for example as a low pressure exhaust gas turbocharger 20 in a charging system 14 according to FIG. 1. The turbines 100, 102 thus act as low pressure turbines 24. In association with FIG. 1 therefore the bypass line 30 of the high pressure turbine 22 extends to a collecting chamber 104 of the respective turbine 100, 102. The collecting chamber 104 can optionally be designed corresponding to the turbine spiral over a periphery thereof. Depending upon the type of high pressure turbine 22 a turbine housing 106 of the respective turbine 100 or 102 can also be formed as a segment housing, such as can be seen in particular in association with FIG. 4 and FIG. 5.

The blow-off valve 34 described in connection with FIG. 1 now comprises in association with FIGS. 2 and 3, besides the collecting chamber 104, a slide member 108 which can be moved with an actuator 64, in which openings of a profile of guide vane 110 are incorporated with a function gap of 0.2 to 0.3 mm. By means of a position of the slide member 108, which is fixedly coupled with the actuator 64, a desired cross-section of the blow-off valve 34 is regulated by means of an effective vane height 112 from a closed to a maximum opened position. An outlet channel of the high pressure turbine 22, through which exhaust gas thus flows, which has been expanded by the high pressure turbine 22, is associated with an inlet flow 114 of the turbine 100 or 102 in a gas-tight manner and is fed from the inlet flow 114 in quasi-axial direction to a turbine wheel 116 of the turbine 100 or 102.

As the exhaust gas is fed via the collecting chamber 104 to the turbine wheel 116 in radial direction of the turbine wheel, the turbine 100 or 102 is thus a combination turbine with quasi two turbines. One of these turbines brings about the radial flow to the turbine wheel 116 and the other turbine the quasi axial flow thereto. The turbine which facilitates the quasi axial flow to the turbine wheel 116 can be described as a fixed geometry axial turbine, as it does not have an adjustment device, for influencing flow parameters. This can, however, possibly be provided.

For the efficient energy conversion of a flow of the exhaust gas in the turbine wheel 116 a guide vane structure 118 is provided with a vane angle which is flat relative to the peripheral direction so that correspondingly high peripheral speeds are generated from a particular turbine ratio of the bypass line 30 to a turbine outlet of the turbine 100 or 102 downstream of the turbine wheel 116.

It should be noted at this point that the turbine which is formed by the collecting chamber 104 can be described as a radial turbine structure and that the radial turbine structure of the turbine 100 comprises a variable slide element to form said blow-off valve 34. The radial turbine of the turbine 102 comprises, in contrast, a rotary vane-guide structure to form the blow-off valve 34.

The respective blow-off valve 34 of the turbine 100 or the turbine 102 therefore has on the one hand the object of providing a mass flow dosing for bypassing of the high pressure turbine 22 and furthermore for a conversion of the high pressure ratios into a high gas flow speed directly before the turbine wheel 116 and, last but not least, the object of defining a flow direction via a guide vane design with an emphasis of a peripheral direction. The subsequent turbine wheel 116 will then convert an existing speed energy corresponding to the Euler machine equation into work.

A consequence of a swirl means which is formed by the guide vane structure 118 is an improvement in a degree of efficiency of a charging system according to the charging system 12 in FIG. 1, in which the turbines 100 or 102 are used. This means an increase in achievable air ratio values or enhancing of a charge exchange of the internal combustion engine. On the other hand the charging system can be regulated with great sensitivity via such a device in an improved situation in a whole core field of the internal combustion engine both in a non-stationary and stationary manner.

In contrast with standard blow-off valves outside of the turbine the blow-off swirl valve shown offers in the respective turbine, besides a favorable linear opening characteristic of the flow cross-section, also a possibility of a high sealing quality in the closed position.

An extension of a blow-off cross-section in the form of the flow cross-section of the blow-off valve 34 to very large values is also conceivable, whereby the bypassing of the low pressure turbine 22 can also be managed as needed. A turbine type according to FIG. 2 with a TRIM100 turbine wheel, whereby therefore an inlet wheel diameter is equal to an outlet wheel diameter, offers an ideal basis for this. The adjustable matrix 108 would be moved in an extreme case so far in the direction of a turbine outlet 120 until an end face 122 of the slide member 108 was over a wheel outlet edge 124. A very large mass flow portion of the portion does not thereby bypass through the high pressure turbine 22 but instead also the turbine wheel 116 of the turbine 100 or 102, which constitute in a charging system 14 according to FIG. 1 a high pressure turbine. The slide member 106 may include a slide sleeve member 105, in particular with a conical section, disposed in the turbine outlet region.

As already indicated, FIG. 3 shows a turbine 102 which forms a combination turbine, wherein said blow-off valve 34 is arranged through rotatable vanes over a radial inlet of the turbine wheel 116, wherein the rotatable vanes form the previously described guide vane structure 118. Through a rotation movement of the guide vanes the flow cross-section to be released and a flow angle of the exhaust gas are determined.

FIG. 3 shows the larger inflow diameter D_{rad} of the radial supply of the exhaust gas to the turbine wheel 116 and in comparison therewith the smaller inflow diameter Dₐₓ of the quasi axial supply of the exhaust gas to the turbine wheel 116.

In FIGS. 4 and 5 the same reference numerals describe the same elements as in FIG. 1.

In contrast with the circuit diagram according to FIG. 1, wherein a single flow high pressure turbine 22 is indicated, the circuit diagrams according to FIGS. 4 and 5 now show a dual flow high pressure turbine 22′, wherein spiral area values differ from inlet flows 199 and 201 in the example shown. These turbines are therefore dual flow asymmetrical high pressure turbines 22′, by means of which exhaust gas recirculation rates of a high pressure EGR system can be influenced.

A control of bypassing quantities of the high pressure turbine 22′ is now provided by the low pressure turbine 24 or an alternative embodiment of a low pressure turbine 24′, whereby in FIG. 4 a single flow bypassing of the high pressure turbine 22′ and in FIG. 5 a dual flow bypassing of the high pressure turbine 22′ are shown. In case of the dual flow bypassing the low pressure turbine 24′ comprises, besides the inlet flow 36, which is connected with an outlet of the high pressure turbine 22′, two separate collecting chambers 38′ and 38″ which are in communication with separate bypass channels 200 and 202 of the high pressure turbine 22′. Said collecting chambers 38′ and 38″ can thereby be designed as twin flow housings or also as segment housings 204 with symmetrical or also asymmetrical back-up behavior depending on the task.

What is claimed is:

1. An internal combustion engine (10) with a high pressure exhaust gas turbocharger (18) and a low pressure exhaust gas turbocharger (20) connected in series on an exhaust gas side (14) of the internal combustion engine (10), each including a turbine (22, 24, 22′, 24′) with a turbine housing (106) through which an exhaust gas of the internal combustion engine (10) is conducted, a bypass (32) extending around the high-pressure turbocharger (18) and including a blow-off valve (34) disposed in the turbine housing (106) of the low pressure exhaust gas turbocharger (20), by means of which the exhaust gas can be directed around the turbine (22) of the high pressure exhaust gas turbocharger (18) for conducting exhaust into an inlet flow (36, 38, 38′, 38″) of the turbine (24, 24′) of the low pressure exhaust gas turbocharger (20), the turbine (24, 24′) of the low pressure exhaust gas turbocharger (20) comprising a first inlet flow passage (38, 38′, 104), by means of which the exhaust gas can be fed to a turbine wheel (116) disposed in the turbine housing (106) of the low pressure exhaust gas turbocharger (20) at the tip of the turbine wheel (116) substantially in radial direction of the turbine wheel (116) and the turbine (24, 24′, 104) of the low pressure exhaust gas turbocharger (20) further comprising a second inlet flow passage (36, 114), for directing the exhaust gas to the turbine wheel (116) of the low pressure exhaust gas turbocharger (20) onto the turbine wheel (116) at a small turbine wheel inlet diameter in a substantially axial or semi-axial direction.

2. The internal combustion engine (10) according to claim 1, wherein the blow-off valve (34) is arranged in the first inlet passage (38, 38′, 104) of the turbine housing (106).

3. The internal combustion engine (10) according to claim 1, wherein the blow-off valve (34) comprises at least one guide vane element.

4. The internal combustion engine (10) according to claim 4, wherein the at least one guide vane element is rotatably mounted.

5. The internal combustion engine (10) according to claim 1, wherein the blow-off valve (34) is formed as a variable guide vane structure (118).

6. The internal combustion engine (10) according to claim 1, wherein the blow-off valve (34) comprises a displaceable adjusting device (108), by means of which a flow cross-section can be controlled.

7. The internal combustion engine (10) according to claim 6, wherein the adjusting device (108) is in the form of a sleeve member (108), by means of which the at least one vane element or the variable guide baffle (118) can be covered at least in areas.

8. The internal combustion engine (10) according to claim 1, wherein the sleeve member (108) includes a device for influencing flow parameters, in particular, a conical slide member sleeve structure (105) which is provided in a wheel outlet region of the turbine wheel (116) of the low pressure exhaust gas turbocharger (20).

9. The internal combustion engine (10) according to claim 1, wherein the inlet flow passages (36, 38, 38′, 38″) have essentially asymmetrical flow cross-sections.

10. The internal combustion engine (10) according to claim 1, wherein the turbine (24, 24′) of the low pressure exhaust gas turbocharger (20) comprises a collecting chamber (104) in the first inlet flow passage (38, 38′, 38′, 104).

11. The internal combustion engine (10) according to claim 1, wherein the turbine housing (24, 24′) of the low pressure exhaust gas turbocharger (20) is in the form of a segment housing (204) or a twin housing.

12. The internal combustion engine (10) according to claim 11, wherein the segment housing (204) or the twin housing includes at least two separate collecting chambers (104) which have a symmetrical or asymmetrical build-up behavior.

13. The internal combustion engine according to claim 1, wherein a turbine wheel inlet diameter is formed equal to a turbine wheel outlet diameter of the turbine (24, 24′) of the low pressure exhaust gas turbocharger (20).

14. The internal combustion engine (10) according to claim 1, wherein an exhaust gas recirculation is provided.

15. A method for operating an internal combustion engine (10) with a high pressure exhaust gas turbocharger (18) and a low pressure exhaust gas turbocharger (20) connected in series therewith and comprising on an exhaust gas side (14) of the internal combustion engine (10) a turbine (22, 24′, 24″), through which exhaust gas of the internal combustion engine (10) can flow, wherein, by way of a bypass (32) with a blow-off valve (34) disposed in a turbine housing (106) of the low pressure exhaust gas turbocharger (20), the exhaust gas can be directed around the turbine (22) of the high pressure exhaust gas turbocharger (18) and the exhaust gas is conveyed into an inlet flow (38, 38′, 38″) of the turbine (24, 24′) of the low pressure exhaust gas turbocharger (20), said method comprising the steps of:
feeding the exhaust gas in dependence on an operating point of the internal combustion engine (10) to a turbine wheel (116) disposed in the turbine housing (106) of the low pressure exhaust gas turbocharger (20) via a first inlet flow (38, 38′, 38″) substantially in radial direction or additionally via a second inlet flow (36) substantially in an axial or semi-axial direction to the turbine wheel (116).

16. The method according to claim 15, wherein by way of the bypass (32) the exhaust gas is conveyed into the first inlet flow (36) of the turbine (24, 24′) of the low pressure exhaust gas turbocharger (20).
